(19) United States
(12) Patent Application Publication
(10) Pub. No.: US 2004/0049407 A1
(43) Pub. Date: Mar. 11, 2004

(54) Method and system minimizing drug to food interactions

(76) Inventor: Michael J. Rosenberg, Cleveland Heights, OH (US)

Correspondence Address: Warren A. Sklar, Nineteenth Floor, 1621 Euclid Avenue, Cleveland, OH, 44115-2191, US

(21) Appl. No.: 10/236,708

(22) Filed: Sep. 6, 2002

(51) Int. Cl. G06F 17/60; G09B 19/00

(52) U.S. Cl. 705/2; 434/127

(57) ABSTRACT

A method for monitoring an individual's drug regimen and meal regimen to reduce the likelihood of a drug-to-food interaction. An ingredient group table is constructed that includes ingredient groups which are known to cause an adverse reaction when combined with a particular drug in an individual. Known drugs are linked to contraindicated ingredient groups listed in the ingredient group table to create a drug-ingredient group table, which includes the known drugs and the linked contraindicated ingredient groups. The drug regimen of an individual is determined from a Physicians' Orders database. The drug-ingredient group table is searched using the individual's drug regimen as the search criteria. Matching drugs along with the linked contraindicated ingredient groups are extracted from the drug-ingredient group table and placed in a personalized drug-ingredient group table. A personalized contraindicated ingredient group table is created by extracting the contraindicated ingredient groups of the personalized drug-ingredient group table. Food items from an institutions menu are linked to the ingredient groups of the ingredient group table to create a food-ingredient group table, which includes the food items and the linked ingredient groups. The meal regimen of an individual is determined from dietary software or other means. The food-ingredient group table is searched using the individual's meal regimen as the search criteria. Matching food items along with the linked ingredient groups are extracted from the food-ingredient group table and placed in a personalized food-ingredient group table. The ingredient groups linked to each food item of the personalized food-ingredient group table are compared to the personalized contraindicated ingredient group table. If there are one or more matching ingredient groups between the two tables, a contraindication warning is issued. If there are no matching ingredient groups, then the meal may be served to the individual.

### FIELD OF THE INVENTION

The present invention relates to a system and method for reducing or avoiding the likelihood of and/or minimizing drug-to-food interactions. More particularly, the invention relates to computerized system, computer software and method which allows health care institutions, for example, efficiently to check a patient's meal for possible drug-to-food interactions.

### BACKGROUND OF THE INVENTION

Numerous individuals depend on medications to combat illness and disease. In order for medications to be effective, the medication(s) ingested by the patient should perform as intended by the prescribing physician. If, after consumption, a medication were rendered less effective or ineffective, the patient's recovery time from an illness or a given condition may be extended and/or his health may be jeopardized.

Various factors can decrease or eliminate a medication's effectiveness. As used herein, the terms medication, drug and the like mean the same. These factors include, for example, drug-to-drug interactions and drug-to-food interactions. A drug-to-drug interaction results when two or more drugs are taken together and one or more of the drugs are rendered less effective or ineffective by the presence of another drug or drugs in the patient's system. A drug-to-drug interaction also may cause one or more side effects or conditions, such as a rash, stomach ache, headache, etc. A drug-to-food interaction, on the other hand, results when a drug is taken in combination with a particular food or food group. An ingredient in the food or food group may render the drug less effective or ineffective. For example, a given drug, when taken in combination with a grapefruit, may be rendered less effective than intended or even ineffective.

Drug-to-drug interactions usually are relatively easy to detect because the side effect(s) can be observed or felt relatively soon after the conflicting or interacting drugs are taken. Drug-to-food interactions usually are less conspicuous in the short term because there usually are no outwardly observable side effects other than increasing the time to cure or to alleviate a given patient condition; and it may take a relatively long time to detect the reduced drug effectiveness.

Medical professionals and the pharmaceutical industry, being aware of drug-to-drug and drug-to-food interactions, have implemented precautionary measures to try to minimize their occurrence. For example, a physician, while prescribing a medication, may instruct a patient to take the particular medication on an empty stomach or to avoid certain over the counter medications while the patient is taking the prescribed medication. A pharmacist may provide an instruction sheet with each medication, part of which may detail which foods and/or drugs to avoid while taking the medication. Pharmaceutical companies provide drug information to the FDA as well as other information service providers. This information includes which drugs should be avoided while on a particular medication, as well as which foods should be avoided while on a particular medication.

Software packages have been developed and marketed which may aid a physician and/or pharmacist in providing the patient with information regarding his medication. A feature of these software packages is to provide drug-to-drug interaction information to the physician and/or pharmacist which then may be conveyed to the patient. For example, a physician may enter the medications he has prescribed to the patient into a computer running the software package. After entering the data, the computer accesses a database (e.g., commercially available databases provided by Multum or First Data Bank) to check if there are potential drug-to-drug interactions. If potential interactions are found, the computer reports the interactions on a display screen and/or printout and the appropriate action may be taken. This action may include, for example, cautions to the prescriber, e.g., the physician, or prescription filler and/or instructions to the patient to take the medication on an empty stomach or to avoid other over the counter drugs.

However, there are no tabulations, databases, or the like pertaining to drug-to-food interactions. Instruction sheets given to patients may have drug-to-food interaction information and/or instructions mixed in with those concerning drug-to-drug matters and, therefore, may be difficult to find, to remember, to follow, and so forth. For these reasons patients and sometimes people giving or “feeding” drugs to patients may not pay as great attention to the drug-to-food matters as to drug-to-drug matters.

Health care institutions, such as nursing homes, assisted living centers, hospitals, etc., provide care to individuals over a period of time ranging from several days or weeks, or even indefinitely. These institutions provide medical care, including medications, as well as every day needs, such as meals and beverages. In many cases the institution has its own kitchen which prepares menus and meals for the residents and serves them in a common dining area. The size of each institution varies and generally can range from less than 50 to more than 500 patients. The larger the institution and the more diverse its patients, the more diverse are the food requirements, menus, medications and, thus, the complexity of the operation and maintaining of care to meet the needs of the patients.

Since the institution is responsible for providing medication and meals to its residents, the institution also is responsible for preventing drug-to-food interactions. Drug-to-food interactions can be difficult to check because two departments are concerned, e.g., the pharmacy department and the dietary department, and the double checking would require that someone, such as a nurse and/or a food server, check the “information sheet” for each drug the patient is taking and then check each meal and snack given to the patient to ensure that a particular food item will not cause an adverse reaction with the prescribed drug. These additional efforts take time and cost labor.

A resident in a nursing home, for example, may take nine or ten different medications every day. Although the medications taken by a patient may remain the same for a number of days, nonetheless medications do vary. Meals are different each day to provide variety and interest and may be served three times per day, while snacks may be served two to three times per day. Therefore, to try to ensure a drug-to-food interaction does not occur, the nurse, for example, would have to check the “information sheet” for each of the ten different drugs for each meal served, including snacks. In short, using the above scenario, the nurse must perform this function fifty to sixty times per day for each patient. This assumes that each meal is of uniform content (e.g. one item). Most likely, a meal will contain several items (e.g. meat, potatoes, vegetables), thus expanding further the number of times the check must be performed. Considering that an institution has numerous residents, one can quickly see that this procedure is very time consuming and inefficient. Unfortunately, because of the time involved, many institutions do not check for drug-to-food interactions and thus residents are not protected from drug-to-food interactions.

Accordingly, there is a need in the art for a method and system for checking for drug-to-food interactions that is efficient and accurate. Additionally, it would be advantageous to automate such checking and to minimize intervention by the institutional staff. Thus, there is a need to improve checking of drug-to-food interactions and, accordingly, to reduce the likelihood thereof.

### SUMMARY OF THE INVENTION

Briefly, according to an aspect of the present invention, a connection is made between a menu or meal regimen and Physicians' Orders in such a way as to reduce or to avoid drug-to-food interactions. By creating ingredient group tables, which are described in greater detail below, linking is provided between foods, dishes, purchased or prepared ingredients, raw ingredients, and the like, on the one hand, with drugs prescribed in Physicians' Orders, on the other hand, so as to reduce or to avoid drug-to-food interactions.

Another aspect of the invention relates to a method of reducing the likelihood of drug-to-food interactions, which includes the steps of comparing the ingredients in at least one of a food, food group, meal and snack intended for serving to an individual with contraindicated ingredients with respect to a drug regimen of the individual and providing an output representative of contraindications encountered.

Another aspect of the invention relates to a computer system for reducing the likelihood of drug-to-food interactions, which includes a processor, a computer program executed by the processor to cause the computer to compare the ingredients in at least one of a food, food group, meal and snack intended for serving to an individual with contraindicated ingredients with respect to a drug regimen of the individual and provide an output representative of contraindications encountered.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a flow chart of a prior art method for minimizing drug-to-food interactions.

FIG. 2A is an illustration showing the present invention providing relationship between dietary matters, e.g., menus/meal regimens, on the one hand, and Physicians' Orders, e.g., drugs, on the other hand, via a link provided using food-ingredient group relationships and drug-ingredient group relationships.

FIG. 2B is a simplified block diagram for a method of minimizing drug-to-food interactions in accordance with the present invention.

FIG. 3 is a flow chart for determining the ingredient groups associated with each food in an individual's meal regimen in accordance with the present invention.

FIG. 4 is a flow chart for determining contraindicated ingredient groups associated with each drug based on an individual's drug regimen in accordance with the present invention.

FIG. 5 is a flow chart for determining if an ingredient group associated with each food in the individual's meal regimen is contraindicated by the individual's drug regimen in accordance with the present invention.

FIG. 6A is an exemplary ingredient group table in accordance with the present invention.

FIG. 6B is an exemplary ingredient group table which includes actual ingredient groups in accordance with the present invention.

FIG. 7 is an exemplary food-ingredient group table in accordance with the present invention.

FIG. 8 is an exemplary personalized food-ingredient group table in accordance with the present invention.

FIG. 9 is an exemplary Physicians' Orders table illustrating information that may be included in Physicians' Orders.

FIG. 10 is an exemplary drug-ingredient group table in accordance with the present invention.

FIG. 11 is an exemplary personalized drug-ingredient group table in accordance with the present invention.

FIG. 12 is an exemplary personalized contraindicated ingredient group table in accordance with the present invention.

FIG. 13 is an exemplary computer system for implementing the method for minimizing drug-to-food interactions in accordance with the present invention.

FIG. 14 is another embodiment of an exemplary computer system for implementing the method for minimizing drug-to-food interactions in accordance with the present invention.

### DESCRIPTION

The following is a description of the present invention in conjunction with the attached drawings, wherein like reference numerals will refer to like elements throughout.

The invention is described below with respect to use in an institution, such as a nursing home, convalescent home, hospital, etc. However, it will be appreciated that the invention may be used in other institutions, environments, scenarios, businesses, etc.

Briefly and as is described in detail below, the present invention provides an efficient method, apparatus and system for avoiding adverse drug-to-food interactions. An ingredient group table is prepared to identify conveniently a collection of ingredient groups that have an adverse drug-to-food interaction with one or more drugs, which may be taken by a patient. One non-limiting example of such an adverse drug-to-food interaction is the reducing of effectiveness of the drug and, thus, the increased time required for the drug to have its intended effect. The method, apparatus and system of the invention are able efficiently to compare food menus intended for respective patients or meal regimens of respective patients with the drug regimens of those respective patients and to use the ingredient group table in connection with the comparisons and the results of the comparisons, thereby leading to a determination of whether there is a contraindicated food intended for a respective patient. If there is such a contraindication, the food may be identified and, if appropriate, avoided, e.g., eliminated from the menu or food regimen for the given patient. A substitute food that is not contraindicated may be substituted.

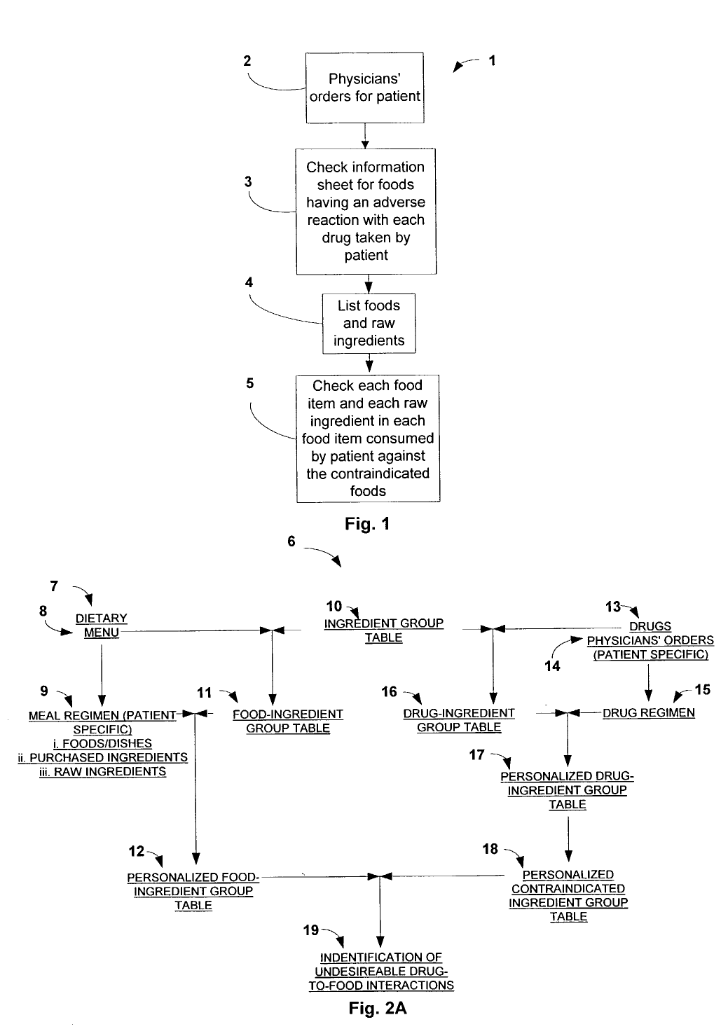

A prior art method 1 for minimizing drug-to-food interactions is illustrated in FIG. 1. Beginning at step 2, each drug prescribed to a patient is written down, e.g., on a sheet of paper or entered in a table or database. The sheet, table or database is commonly referred to as the Physicians' Orders or Medical Records. The Physicians' Orders are personalized to the patient, e.g., due to the patient's needs, the physician orders or prescribes a drug or drugs. At step 3 a person checks an Information Sheet to determine whether there are any foods, food groups or ingredients that would cause an adverse drug-to-food reaction with each of the drugs in the Physicians' Orders for the given patient; these foods would be referred to as contraindicated foods. At step 4 the contraindicated foods, food groups or ingredients may be listed, if desired. At step 5 a person checks each food, food group or ingredient intended to be eaten or fed to a patient, e.g., consumed or ingested by the patient, for a given meal, snack, or the like, relative to the contraindicated foods to determine whether one or more of the foods should not be given to the patient. The person or persons who would make the above checks usually would be one or more employees of the institution, e.g., a nurse, a food server, a person in the dietary department, etc. While this method may be effective when the number of individuals in a “check group” is small, it quickly becomes inefficient as the check group increases in size and in a population whose individuals would be prescribed multiple drugs, as typically would be found in a health care institution. There is a further complicating factor to the checking mentioned just above. It is possible that the contraindication, e.g., the adverse drug-to-food interaction, may be on account of an ingredient in a food, a wholly prepared food that includes several ingredients, etc.

In the description below reference will be made to an “ingredient group”. As used herein, ingredient groups are food related items that are listed in the drug literature as having an adverse reaction with a particular drug. An ingredient group may be an ingredient (sometimes referred to as a “raw ingredient”), such as, for example, wheat and caffeine. Note that the ingredient group also may be a food, such as a grapefruit, for example. The ingredient group may be a class of foods, e.g., game meat and shell fish. With the above in mind, then, it will be appreciated that an ingredient group includes things that are ingredients, whole foods, and groups of foods. Thus, an ingredient group can be a subset, equal to, or a super set of a food, as will be discussed in more detail below.

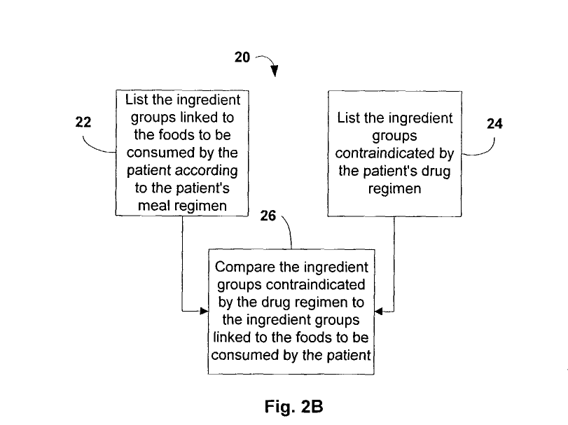

In the present invention for which an overview is illustrated schematically in FIG. 2A, the data of interest is the drug-to-food interaction information for each patient leading to determination of contraindication. According to the invention, information on contraindicated ingredient groups with respect to drugs is obtained and assembled, e.g., from drug information provided by drug manufacturers, to form an ingredient group table. Using the ingredient group table, a known drug regimen of a patient and a known meal regimen of a patient, a personalized drug-ingredient group table and a personalized food-ingredient group table are prepared, according to the present invention. As mentioned above, the ingredient group table of the present invention includes ingredient groups that can be a subset, equal to, or a super set of a food to which it is linked. Generally in software (when linking tables) there is a parent table and a child table, where the child table is a subset of the parent table. In the present invention, the child table, in addition to being subset of the parent table, can be equal to or a super set of the parent table. A unique feature of the present invention is that there is an ingredient group table without repeat entries, e.g., each ingredient group is listed once. All drugs and all contraindicated foods, food groups or ingredients are linked to the ingredient group table. The fact of table creation makes it proper to identify foods with links to drugs. In contrast, the prior art method lists food items, but the user must determine whether a food item is contraindicated, which may not be clear. For example, a user may be required to determine whether a particular meat is a “game meat”. As will be appreciated from the description below, the invention provides in effect a linking between the above mentioned tables to determine which food items, if any, in a patient's meal regimen may cause a drug-to-food interaction.

Linking, as referred to herein, includes associating two or more items together, such that when one item is selected, the linked item is also selected. For example, if item “A” is in one table and item “B” is in a second table, and item “A” is linked to item “B” in a third “linked” table, then a search within the linked table for item “A” will return item “A” and item “B”.

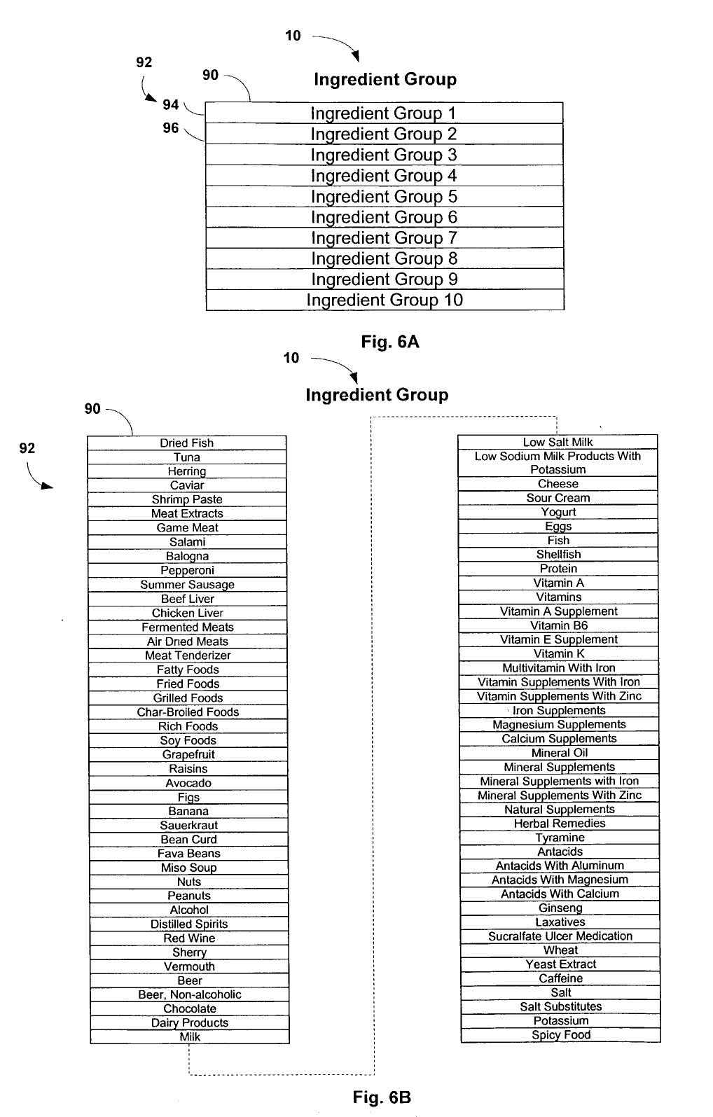

Drug manufacturers provide drug information to the FDA as well as other service providers, such as First Data Bank (owned by Hearst Corporation) and Multum (owned by Cerner), who are commercial suppliers of drug information databases. The drug information concerns contraindicated foods, food groups and ingredients that, when ingested by an individual in combination with a particular drug, may cause an adverse reaction, e.g., reduce or eliminate the drug's effectiveness. Such drug information typically has been unorganized information within text files of information sheets. In the present invention, the drug information regarding the food, food groups and ingredients is compiled and placed in a table to form the ingredient group table, where each food, food group or ingredient is listed only once. Each drug is linked to a corresponding contraindicated ingredient group or groups (assuming the drug has a contraindicated ingredient group) to form the drug-ingredient group table. The ingredient group table and the drug-ingredient group table are described in more detail below with respect to FIG. 6A and FIG. 10 respectively.

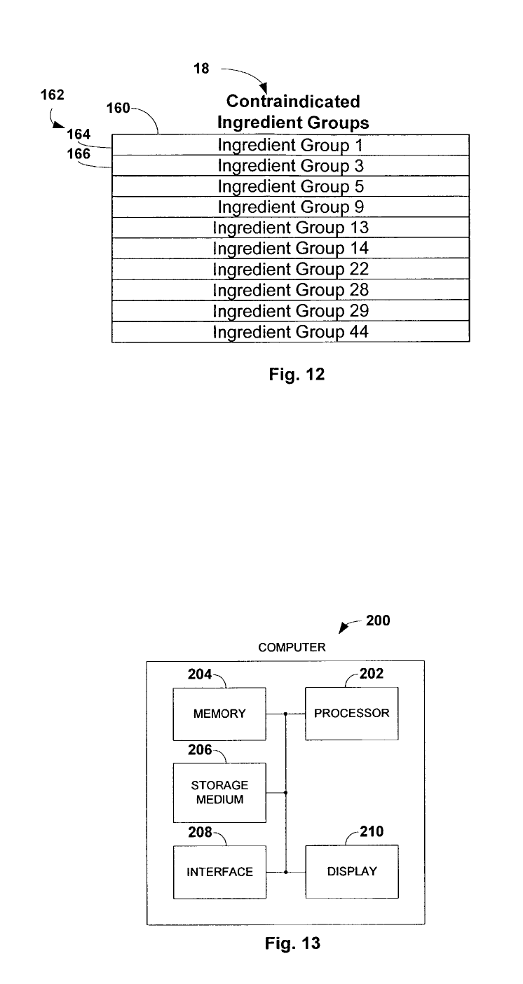

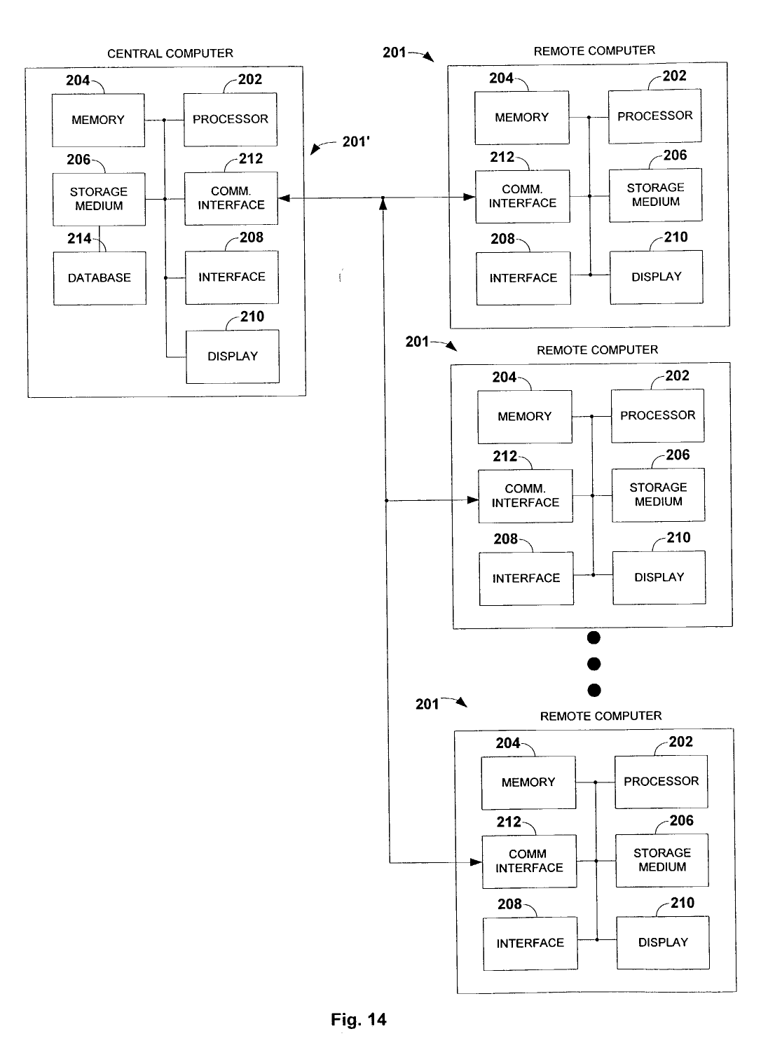

From the drug-ingredient group table and the patient's drug regimen, a personalized drug ingredient group table is derived. The personalized drug-ingredient group table relates to ingredient groups that should not be consumed by a patient, e.g., the contraindicated ingredient groups. The personalized drug-ingredient group table includes ingredient groups that cause an adverse reaction with each drug in a patient's drug regimen. The elements of the personalized drug-ingredient group table are derived using the drug-ingredient group table and the patient's drug regimen, as determined from the Physicians' Orders. The drug-ingredient group table is “searched” using the patient's drug regimen as the search criteria. Any drug from the patient's drug regimen that is found in the drug-ingredient group table is extracted, along with the “linked” ingredient group, and placed in the personalized drug-ingredient group table. The contraindicated ingredient groups of the personalized drug-ingredient group table are extracted (duplicate ingredient groups are discarded) and placed in another table, which is referred to as the personalized contraindicated ingredient group table. Thus, the personalized contraindicated ingredient group table includes a listing of the ingredient groups that are contraindicated by the patient's drug regimen. The personalized drug-ingredient group table and the personalized contraindicated ingredient group table are described in more detail below with respect to FIG. 11 and FIG. 12.

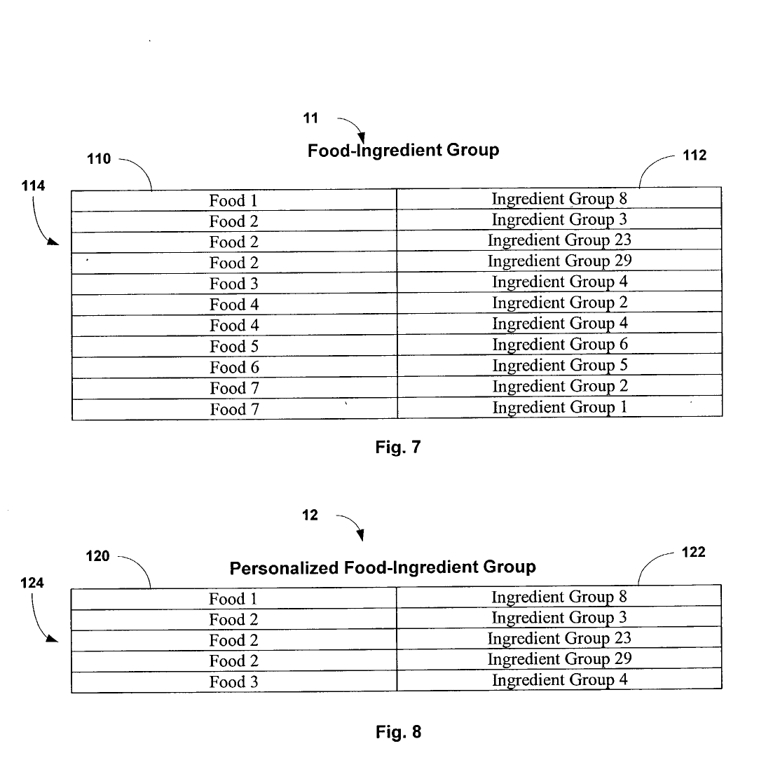

Using the previously described ingredient group table, a food-ingredient group table is derived. The food-ingredient group table links ingredient groups to foods that may be served in an institution. The food-ingredient group table is derived by linking food items from an institutions menu to corresponding ingredient groups from the ingredient group table. The food-ingredient group table may additionally or alternatively link directly to foods and/or raw ingredients. The level of detail of the food-ingredient group table may be up to the end user of the invention. For example, a food item on the menu may be chocolate pudding, which may be entered in the food-ingredient group table as “chocolate pudding” with links to the respective ingredient groups, e.g., caffeine and dairy products. Alternatively, the ingredients of chocolate pudding, e.g., cocoa, milk, sugar, etc., may be linked to the ingredient groups, e.g., cocoa to caffeine, milk to dairy products. The food-ingredient group table links the foods that may be served to a patient in an institution to their associated ingredient groups. The food-ingredient group table is described in more detail below with respect to FIG. 7.

Using dietary software or any other meal planning method, the patient's meal regimen is determined. Using the patient's meal regimen as the search criteria, the food-ingredient group table is searched. Matching food items along with the linked ingredient groups are extracted from the food-ingredient group table and place in a new table, which is referred to as the personalized food-ingredient group table. The personalized food-ingredient group table links the foods that are scheduled to be served to a patient to their associated ingredient groups. The personalized food-ingredient group table is described in more detail below with respect to FIG. 8.

Using the personalized food-ingredient group table and the personalized contraindicated ingredient group table, it is possible to determine which food in the menu is contraindicated for a given patient. Furthermore, as will be described below, the invention also may provide information to substitute for a food linked to a contraindicated ingredient group of a given menu planned for a patient, a different food that is not contraindicated, yet provides suitable nutritional value or other desirable characteristic for the patient.

A brief note, here, regarding the description of tables and use of tables and the term “table(s)” as presented herein, reference to table may be an actual table that is prepared and stored electronically, e.g., on a hard or floppy drive of a computer or on a CD-ROM, DVD, etc.; the table may be printed; the table may be a virtual table in that it is one set up in memory of a computer or the like, is used and is erased, removed, deleted, etc., until it next needs to be compiled for use. A table may be an organized group of data; or it may be data that is extracted from a source. A table may be in the form of a spread sheet, e.g., as that sold under the trademark Excel by Microsoft Corporation; it may be in the form of a database, e.g., as that sold under the trademark Oracle by Oracle Corporation; it may be in a word processing format; it may be in some other format or assemblage of information. The precise form of table and whether it exists long term or only briefly during use is not material to the invention; rather, it is the use of information that may be stored in tabular form or in some other form or derived from some source that is useful in the present invention.

As illustrated in FIG. 2A, the invention provides a relationship shown at 6 between the dietary part 7 of a patient's needs and the drug part 13 of a patient's needs. It is noted that although the term “patient” is used herein, that term is to be construed in its broadest sense, and includes, for example, residents of nursing homes, home care individuals, or virtually any person who needs to take drugs. The dietary part 7 of a patient's needs concerns the foods the patient eats. These foods may be categorized in high level form as the menu of food that is served by an institution; thus a menu may not be patient specific. A menu 8, such as a breakfast menu, may include a number of food items, e.g., scrambled eggs, pancakes, toast, jelly, butter, fried potatoes, glass of milk, glass of orange juice, and coffee that are served for breakfast on a given day. On another day, for example, oatmeal may be substituted for the eggs and potatoes, and so forth. The menu may be such collection of foods or dishes that an institution serves or is expected to serve. An example just given is a breakfast menu for a given day; but it will be appreciated that the menu may be prepared for a number of meals in a given day, for a given time frame longer than a day, such as for several days, a week, a month, etc. A menu or standard menu may apply to many individual patients or may be modified for specific patients. A menu is simply a list of foods (also known as dishes) a patient will be served for a given meal or snack.

The foods in a menu 8 that make up a patient's meal regimen 9 may be categorized as (i) dishes, foods or food items, (ii) purchased ingredients, and/or (iii) raw ingredients. Examples of dishes, foods or food items are the mentioned scrambled eggs, toast, milk, juice, etc., and each of these food items may be an ingredient itself, such as the milk or juice, or may be prepared from one or more other ingredients, such as the eggs (including a mixture of eggs, salt and milk) or the toast (including flour, milk, salt, sugar, eggs, etc., depending on the recipe used to make the bread). The foods also may be described by so-called purchased ingredients, e.g., ground flour, powdered sugar, mixed spices, ketchup. The various foods/dishes, which may be described by purchased ingredients, raw ingredients, etc. in the menu 8 of the dietary part 7 are not patient specific, although a given meal regimen 9 usually would be patient specific to fill the dietary needs and desires of a given patient.

As was described above, each of the menu, foods/dishes, purchased ingredients, and raw ingredients, as well as other food items that for one reason or other would not be broadly grouped therein, may be linked to one or more ingredient groups, which is indicated at 10 in the relationship illustration 6 of FIG. 2A. According to the present invention, each food from the menu 8 (directly or indirectly through raw or purchased ingredients) may be linked to one or more ingredient groups to create a food-ingredient group table 11. The food-ingredient group table 11 details the ingredient groups linked to the foods that an institution may serve to a patient based on the menu 8. Using the food ingredient group table 11 and the patient's meal regimen 9, a personalized food-ingredient group table 12 is created. The personalized food-ingredient group table 12 includes the specific foods and their linked ingredient groups that a patient, based on his meal regimen 9, is scheduled to consume.

At 14 in the relationship illustration of FIG. 2A Physicians' Orders are shown. The Physicians' Orders are patient specific; for example, they concern the list of drugs 15 that are being taken or to be taken by a given patient. As used herein, the list of drugs 15 also may be referred to as the drug regimen 15. According to the present invention, the drug regimen 15 along with the drug-ingredient group table 16 are used to create a personalized drug-ingredient group table 17 from which the personalized contraindicated ingredient group table 18 is derived. The drug-ingredient group table 16 details the ingredient groups that are contraindicated by the patient's drug regimen 15. These ingredient groups may be referred to as the contraindicated ingredient groups.

In a sense the relationships shown in FIG. 2A are links between the items composing a menu/meal regimen and ingredient groups and links between a drug regimen and respective contraindicated ingredient groups. Thus, the personalized contraindicated ingredient group table 18, in combination with the personalized food-ingredient group table 12, permit the identification of drug-to-food interactions that are undesirable 19.

Referring now to FIG. 2B, a simplified block diagram for a method 20 for minimizing drug-to-food interactions in accordance with the present invention is illustrated. The method 20 may be considered as divided in three different parts, which cooperate to link or to provide a link between menu(s) or meal regimen(s) and drug regimens. The menu(s) or meal regimen(s) are formed of food items (which may be linked to their ingredient groups) and the drug regimens are formed of drugs prescribed to the patient by a physician. Part one 22 determines which ingredient group(s) are present in each food of the planned meals of each patient. Part two 24 determines which ingredient group(s) should not be consumed by the patient on account of an undesirable drug-to-food interaction. These ingredient groups are referred to as the contraindicated ingredient groups. Finally, Part three 26 compares the contraindicated ingredient group(s) to the planned ingredient group(s) and determines if there is a match. If no match is found, then the patient's meal may not produce a drug-to food interaction and the meal may be given to the patient. If a match were found, however, then the foods containing the contraindicated ingredient group would be removed from the meal. Possibly a substitute food item may be put in place of the removed ingredient group.

Thus, the invention provides a link between menus or meal regimens, on the one hand, with Physicians' Orders or drug regimens, on the other hand, to reduce the likelihood, to minimize, or to avoid undesirable drug-to-food interactions. Menus or meal regimens may be the same for a number of patients or may be different or specialized for a given patient. Drug regimens usually are different from patient to patient. The invention determines what foods contain the ingredient groups that are contraindicated with respect to the drug(s) being taken by a given patient, e.g., tend to cause an undesirable drug-to-food interaction. Therefore, undesirable affects of food with respect to drugs may be avoided. Alternative food items possibly may be suggested, and, therefore, may be substituted for a contraindicated food item.

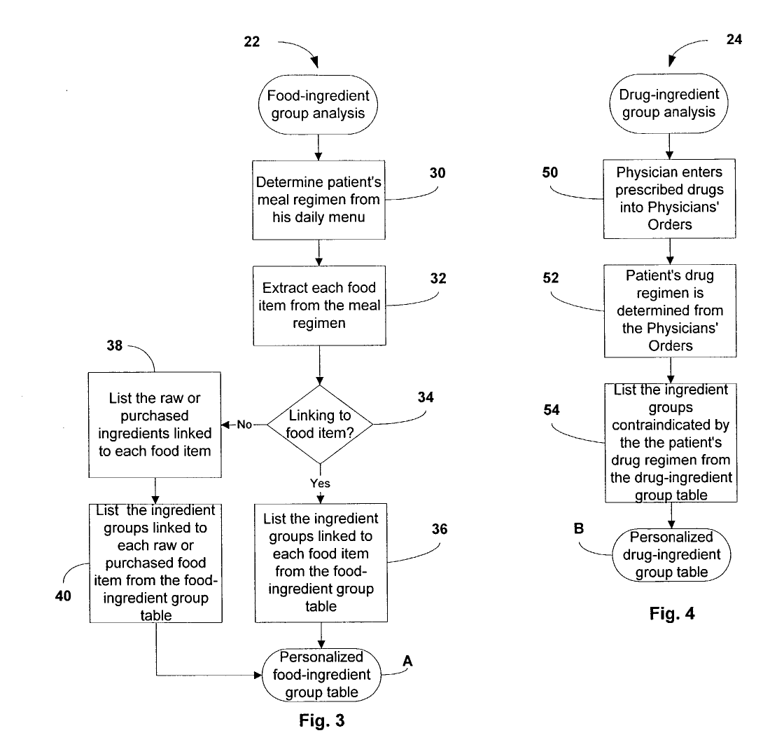

Referring now to FIG. 3, part one 22 of the method 20 is illustrated. Beginning at step 30, the patient's daily meal regimen 9 is assembled. Generally, health care institutions have a dietician on staff that plans, through the aid of dietary software, the meals for the residents. In such institutions, the meal regimen for each patient may be extracted from the dietary software and placed in a table. Generally, in institutions without dietary software, meals are still planned in advance. In such cases, however, the table will need to be created manually. Once created, the table can be maintained with minimal effort on the part of the health care institution.

In step 32, a record of each food item is extracted from the patient's meal regimen 9. Next at step 34, the level of linking present in the food-ingredient group table 11 is determined. As discussed previously, the level of linking in the food-ingredient group table 11 may be up to the end user of the invention. Examples of linking in the food-ingredient group table include ingredient groups linked to food items or ingredient groups linked to food ingredients. If the linking used in the food-ingredient group table is at the “food item” level, e.g., the ingredient group “caffeine” linked to the food item “chocolate pudding”, then the linked ingredient groups for the particular food item may be determined, as shown in step 36. The ingredient groups may be determined by searching the food-ingredient group table 11 for each food item in the patient's meal regimen 9. When a particular food item is found in the food-ingredient group table 11, the linked ingredient groups for the food item are found as well. For example, a particular food item within a patient's meal regimen may be chocolate pudding. Searching the food-ingredient group table 11 for the food item “chocolate pudding” may return a list of ingredient groups that include caffeine and dairy products. The food item and the linked ingredient groups are placed in a table, which is referred to as the personalized food-ingredient group table 12. The personalized food-ingredient group table 12 is a subset of the food-ingredient group table, e.g., it contains the foods/ingredients and the linked ingredient groups that the patient is scheduled to consume. Thus, the personalized food-ingredient group table contains all the food items and the associated ingredient groups that a given patient will consume in a given time period, e.g., for a given meal or for a day, a week, etc. The personalized food-ingredient group table 12 is described in more detail below with respect to FIG. 8.

If, however, the linking in the food-ingredient group table is done at a lower level (ingredients), then the ingredients of chocolate pudding e.g., cocoa, sugar, milk, etc., must be determined before the linked ingredient groups for the particular food item may be listed in the personalized food-ingredient group table 12, as shown in step 38. Moving to step 40, once the ingredients of each food item are determined, then the linked ingredient groups for the particular food item may be listed in the personalized food-ingredient group table 12 in the same manner described above.

It is noted that a separate personalized food-ingredient group table 12 may be prepared for each patient, if desired. If the meals for a number of patients usually are the same for each patient, possibly the same personalized food-ingredient group table 12 may be used for each of those patients.

Referring to FIG. 4, a detailed diagram of Part two 24 of the method 20 is illustrated. Beginning at step 50, a physician or any other qualified individual enters each drug prescribed to a patient into a database, such as, for example, a Physicians' Orders database 14. Physicians' Orders are well known in the art and will not be discussed in detail herein. Briefly, Physicians' Orders contain an array of information relating to each patient. For example, the Physicians' Orders 14 may contain the name of the treating physician, the drugs currently prescribed to the patient, the drug start date, the drug stop date, etc.

Moving to step 52, each patient's drug regimen 15 is determined from the Physicians' Orders 14. A record of each prescribed drug is extracted from the Physicians' Orders and organized in a table. Next, contraindicated ingredient groups based on the patient's drug regimen are listed, as shown in step 54. As discussed previously, the drug-ingredient group table 16 lists all known drugs and the linked ingredient groups that, when taken in combination, produce an undesirable affect. By searching the drug-ingredient group table 16 for drugs that are included in the patient's drug regimen 15, a list of contraindicated ingredient groups for the patient's drug regime may be obtained. The contraindicated ingredient groups, along with the linked drugs, may be extracted from the drug-ingredient group table 16 and placed in another table, which is referred to as the personalized drug-ingredient group table 17. Thus, the personalized drug-ingredient group table is a subset of the drug-ingredient group table. The personalized drug-ingredient group table 17 allows for the extraction of a list of ingredient groups that should be avoided by the patient while on the particular drug regimen.

For example, caffeine is known to reduce the effectiveness of Drug 3 and thus is listed in the drug-ingredient group table 16 and linked to Drug 3. A physician has prescribed Drug 1, Drug 2 and Drug 3 to Patient 1 and has entered each drug into the Physicians' Orders 14. Prior to serving a meal to Patient 1, Patient 1's drug regimen 15 is extracted from the Physicians' Orders 14, revealing Drug 1, Drug 2 and Drug 3. The drug-ingredient group table 16 is searched using the patient's drug regimen as the search criteria. Any drug in the patient's drug regimen 15 that is found in the drug-ingredient group table 16 is extracted, along with the linked ingredient group, and placed in the personalized drug-ingredient group table 17. Assuming that Drug 1 and Drug 2 do not have a contraindicated ingredient group and caffeine is the only contraindicated ingredient group for Drug 3, the personalized drug-ingredient group table of the present example will provide a list of a single contraindicated ingredient group, which is caffeine. Thus, caffeine is identified as a contraindicated ingredient group for Patient 1.

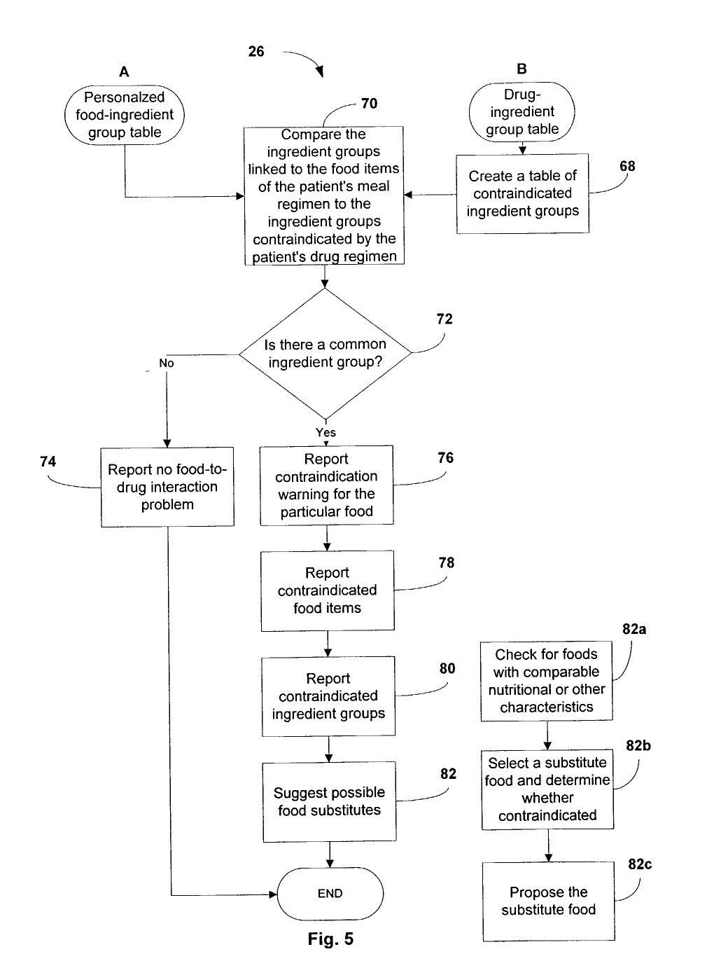

Referring now to FIG. 5, part three 26 of the method 20 (FIG. 2B) is illustrated. Blocks A and B represent “connections” or relation to parts one and two (FIGS. 3 and 4). Beginning at step 68, the list of contraindicated ingredient groups are extracted from the personalized drug-ingredient group table 17 to form the personalized contraindicated ingredient group table 18. At step 70, the personalized food-ingredient group table 12 generated in part one 22 and the personalized contraindicated ingredient group table 18 are compared. In particular, the ingredient groups linked to each food of the patient's meal regimen, as determined from part one, are compared to the contraindicated ingredient groups. At step 72, it is determined whether the same ingredient group appears in both tables for each food. If there are no common ingredient groups between the tables, then at step 74 a report is issued that a drug-to-food interaction will not occur. If, on the other hand, there are common ingredient groups between both tables, then at step 76 a contraindication alert or warning is issued. An output may be provided to inform an individual of the results of the analysis. The output may be any information discernable by a person. For example, the output may be a message, sound, light, video or any other indicator that conveys the results of the analysis. The output also may be a signal or a lack of a signal that can be used by another piece of equipment or person to indicate that the individual should or should not be served a particular food item.

Steps 78 and 80 may provide further information regarding the contraindication alert or warning. In particular, step 78 reports the specific food item or food items that are contraindicated by the drug regimen, while step 80 reports the specific ingredient(s) or ingredient group(s) that are contraindicated by the drug regimen. Moving to step 82, possible alternative food items may be suggested that may not be contraindicated by the drug regimen. For example, wheat bread may have been contraindicated by the drug regimen, but oat or spelt bread may not be contraindicated by the drug regimen. Accordingly, a suggestion may be made to substitute oat bread for wheat bread.

Referring to FIG. 6A, an ingredient group table 10 is illustrated. The ingredient group table 10 has a single column 90, which is referred to as the ingredient group 90. Each row 92 of the ingredient group table 10 includes one ingredient group. For example, the first row 94 of the ingredient group table 10 includes “Ingredient Group 1”, the second row 96 includes “Ingredient Group 2”, and so forth. It is noted that the size of the ingredient group table may change as new foods and/or drugs are developed, and the present illustration is merely exemplary.

Referring now to FIG. 6B, which is similar to FIG. 6A, an ingredient group table is illustrated that contains actual ingredient group names in accordance with the present invention. The ingredient groups listed, when ingested by an individual in combination with a particular drug, may cause an adverse reaction.

Referring to FIG. 7, a food-ingredient group table 11 is illustrated. The food-ingredient group table 11 has two columns. The first column is referred to as the food item 110 and includes the name or identification (ID) of each food item that may be served to the patient. The second column is referred to as the ingredient group 112 and includes an ingredient group linked to the respective food item. Each row 114 of the food-ingredient group table 11 includes one food item and one ingredient group. Thus, if multiple ingredient groups are linked to a particular food item, then the food item will appear in multiple rows 146 of the food-ingredient group table 11, and each row will correspond to one ingredient group.

In some instances, the food item and the ingredient group may be one in the same. For example, if the food item were a grapefruit, then the ingredient group also would be grapefruit. Depending on the meals served by the institution, the size of the food-ingredient group table 11 can be very large.

It is noted that while the food item 110 is listed as “Food 1”, “Food 2”, food is to be construed to include food items, purchased ingredients or raw ingredients. For example, the food item may be a prepared dish, e.g. spaghetti. Alternatively, the food item may be an ingredient (purchased or raw). This construction also applies to the personalized food-ingredient group table, which is discussed below.

Referring now to FIG. 8, an exemplary personalized food-ingredient group table 12 is illustrated. The personalized food-ingredient group table 12 is a table that may be personal to each patient in the institution. The personalized food-ingredient group table 12 contains the food items and ingredient groups that a patient is scheduled to consume in a particular meal (or multiple meals). The personalized food-ingredient group table 12 is similar to the food-ingredient group table 11 of FIG. 7, except table 12 is personalized to the meal(s) planned to be served to a given patient. Thus, the personalized food-ingredient group table 12 is a subset of the food-ingredient group table 11, e.g., the food-ingredient group table 11 includes all of the items in the personalized food-ingredient group table 12. The personalized food-ingredient group table 12 includes two columns. The first column is referred to as the food item 120 and includes the name or ID of each food item that will be served to the patient. The second column is referred to as the ingredient group 122 and includes an ingredient group linked to the food item. Each row 124 of the personalized food-ingredient group table 12 includes one food item and one ingredient group. Thus, if multiple ingredient groups were linked to a particular food item, then the food item would appear in multiple rows 124 of the personalized food-ingredient group table 12, and each row would correspond to one ingredient group.

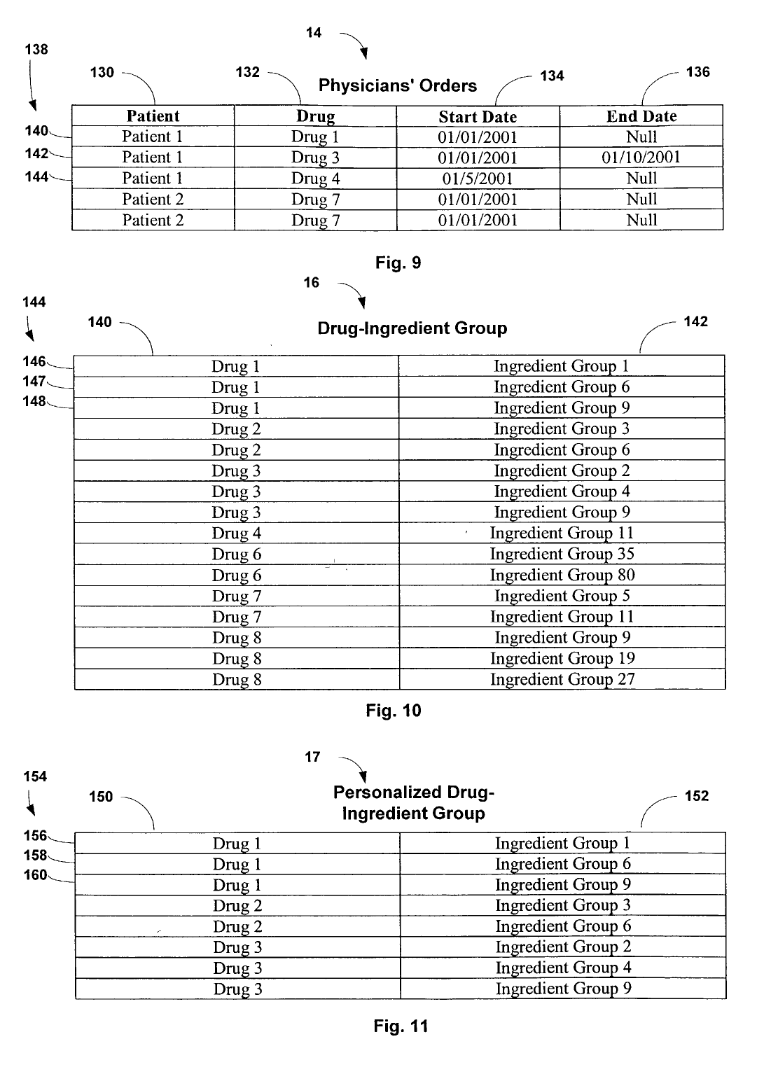

Referring to FIG. 9, an exemplary Physicians' Orders table 14 is illustrated. The table 14 includes four columns. The first column is referred to as the patient name or ID 130 and, as the name suggests, contains the patient's name or ID. The second column is the drug name or ID 132 and includes each drug the patient has been prescribed. The third column is the start date 134 and lists the date that the patient began taking the particular drug. The fourth column is the end date 136 and lists the date the patient will stop taking the particular drug. Each row 138 of the Physicians' Orders 14 includes a single entry of the above described elements for each patient. Patients that are taking multiple medications will have multiple entries in the table. For example, Patient 1 is taking three different medications, Drug 1, Drug 3 and Drug 4. Drug 1 has a start date of Jan. 1, 2001 and continues indefinitely. Drug 3 has a start date of Jan. 1, 2001 and an end date of Jan. 10, 2001. Drug 4 has a start date of Jan. 5, 2001 and continues indefinitely. Referring to the Physicians' Orders, Patient 1 has three separate entries, one for each drug prescribed. The first entry 140 includes the patient's name or ID (Patient 1), the drug name or ID (Drug 1), the start date (Jan. 1, 2001) and the end date (no entry—indefinite). The second row 142 contains the patient's name or ID (Patient 1), the drug name or ID (Drug 3), the start date (Jan. 1, 2001) and the end date (Jan. 10, 2001). The third row 144 contains the patients name or ID (Patient 1), the drug name or ID (Drug 4), the start date (Jan. 5, 2001), and the end date (null—indefinite). Similar information is presented for Patient 2, and so on.

The Physicians' Orders illustrated in FIG. 9. is merely exemplary and other forms of the table may be created without departing from the scope of the present invention. For example, the table may be organized in a different manner than presented in FIG. 9 (e.g., a single row for each patient and multiple columns to handle each drug the patient is prescribed).

Referring now to FIG. 10, an exemplary drug-ingredient group table 16 is illustrated. The drug-ingredient group table includes a list of drugs and the corresponding contraindicated ingredient groups. As detailed above, the drug-ingredient group table 16 links the drugs to ingredient groups that are known to produce an adverse reaction when taken with the respective drug or drugs (e.g., reduce or eliminate the drug's effectiveness). The drug-ingredient group table 16 contains two columns. The first column is referred to as the drug name or ID 140 and includes the name or ID of each drug that may have an adverse reaction with a particular ingredient group. The second column is referred to as the contraindicated ingredient group 142 and contains the ingredient groups that are contraindicated by each drug listed in the drug name or ID 140. Each row 144 of the drug-ingredient group table 16 includes one drug and one ingredient group. Thus, if for a given drug there are multiple ingredient groups that are contraindicated by the drug, then the drug will appear in multiple rows 144 of the drug-ingredient group table, and each row will include the drug name or ID and a contraindicated ingredient group. For example, “Drug 1” is shown in the drug-ingredient group table as being contraindicated by Ingredient Group 1, Ingredient 6 and Ingredient Group 9. Accordingly, “Drug 1” appears in the first row 146, the second row 147 and the third row 148. Each row includes a different contraindicated ingredient group. Note that Drug 5 is not listed in the ingredient group table, as it does not have a contraindicated ingredient group.

It is noted that the drug-ingredient group table 16 described above is merely exemplary and other forms of the table may be created without departing from the scope of the invention. For example, the drug-ingredient group table 16 may be constructed such that each drug appears in only one row 144 and additional columns exist to allow for additional contraindicated ingredient groups to accommodate drugs that have multiple contraindicated ingredient groups.

Referring now to FIG. 11, an exemplary personalized drug-ingredient group table 17 is illustrated. The personalized drug-ingredient group table 17, which is similar to the drug-ingredient group table 16, is a table that is personal to each patient in the institution. As detailed above, the personalized drug-ingredient group table 17 links the drugs in the patient's drug regimen to ingredient groups that are known to produce an adverse reaction when taken with the respective drug or drugs (e.g., reduce or eliminate the drug's effectiveness). The personalized drug-ingredient group table 17 contains two columns. The first column is referred to as the drug name or ID 150 and includes the name or ID of each drug in the patient's drug regimen. The second column is referred to as the contraindicated ingredient group 152 and contains the ingredient groups that are contraindicated by each drug listed in the drug name or ID 150. Each row 154 of the drug-ingredient group table 17 includes one drug and one ingredient group. Thus, if for a given drug there are multiple ingredient groups that are contraindicated by the drug, then the drug will appear in multiple rows 154 of the drug-ingredient group table, and each row will include the drug name or ID and a contraindicated ingredient group. For example, “Drug 1” is shown in the drug-ingredient group table as being contraindicated by Ingredient Group 1, Ingredient Group 6 and Ingredient Group 9. Accordingly, “Drug 1” appears in the first row 156, the second row 158 and the third row 160. Each row includes a different contraindicated ingredient group.

It is noted that the personalized drug-ingredient group table 17 described above is merely exemplary and other forms of the table may be created without departing from the scope of the invention. For example, the personalized drug-ingredient group table 17 may be constructed such that each drug appears in only one row 154 and additional columns are available for each additional contraindicated ingredient group to accommodate drugs that have multiple contraindicated ingredient groups.

As described above, the personalized drug-ingredient group table 17 includes the drugs of the patient's drug regimen linked to the contraindicated ingredient groups, if any. Of particular interest is the list of contraindicated ingredient groups, as these ingredient groups can be used to determine which food items should not be consumed by the patient. It is noted that the contraindicated ingredient groups listed in the personalized drug ingredient group table 17 may appear multiple times since multiple drugs each may be linked to a particular ingredient group. The contraindicated ingredient groups of the personalized ingredient group table are extracted and placed in another table, which is referred to as the personalized contraindicated ingredient group table 18 and shown in FIG. 12. Obviously, multiple entries of a particular contraindicated ingredient group may be discarded, and each contraindicated ingredient group only appears once in the personalized contraindicated ingredient group table 18. The personalized contraindicated ingredient group table 18 is similar to the ingredient group table 10 in construction, but typically will include less ingredient groups. The personalized contraindicated ingredient group table 18 has a single column 160, which is referred to as the contraindicated ingredient group 160. Each row 162 of the personalized contraindicated ingredient group table 18 includes one ingredient group. For example, the first row 164 of the ingredient group table 18 includes “Ingredient Group 1”, the second row 166 includes “Ingredient Group 3”, and so forth. It is noted that it is possible for the personalized contraindicated ingredient group table 18 to be equivalent to the ingredient group table 10. Such an outcome, however, is unlikely.

Referring to FIG. 13, a computer system 200 for executing the method in accordance with the present invention is illustrated. The computer system 200 includes a processor 202 and a memory 204, which are used to execute code stored on a storage medium 206. The computer system 200 also includes an interface 208, such as, for example, a keyboard, a mouse, a touch screen, etc. The interface allows a user to enter and to manipulate data in the computer system 200. A display 210, such as a CRT or an LCD, provides visual information to the user.

The computer system 200 does not require an interface to another computer system, although one may be present. The computer system 200 has all the required hardware and software modules, including the relevant data tables, e.g., the ingredient group table 14 and the food-ingredient group table 15, within the computer system. The computer system 200 may be a portable computer system, such as a lap top computer, or it may be a desk top computer system.

In an alternative embodiment, a computer system 200′ is illustrated in FIG. 12. The computer system 200′ is similar to the computer system 200 of FIG. 11. The computer system 200′, however, includes multiple computers. One or more remote computers 201 may communicate to other remote computers 201 or to a central computer 201′. The remote computers 201 and the central computer 201′ each include a processor 202 and a memory 204, which are used to execute code stored on a storage medium 206. Each computer 201, 201′ in the computer system 200′ also includes an interface 208, such as, for example, a keyboard, a mouse, a touch screen, etc. The interface allows a user to enter and to manipulate data in each computer. A display 210 provides visual information to the user. A communications interface 208, such as, for example, a network interface card, allows each computer 201, 201′ in the computer system 200′ to communicate to other computer systems in a network configuration. Computer networks are well known by those skilled in the art and will not be discussed herein. Alternatively, the communications interface may be a connection to the internet.

The central computer 201′, such as a network server, may be connected to a group of remote computers 201. The central computer system 201′ includes the elements described in each remote computer 201, namely a processor 202, memory 204, storage medium 206, interface 208, display 210 and communications interface 212. The central computer 201′ also includes the relevant databases 214 that may be accessed by the remote computers 201. These databases include, for example, the ingredient group table 14 and the food-ingredient group table 15. The remote computers 201 may access the tables through the communications interface 212 from a remote location, thus eliminating the need to maintain multiple tables on multiple computers.

The computer systems described above are used to implement the methods of the invention, e.g., for minimizing drug-to-food interactions. A person who has ordinary skill in the art of computer programming, using the flow charts provided in the drawings, may write code that a computer can execute to carry out the method for minimizing drug-to-food interactions.

For example, code may be written to cause the computer to determine the ingredient groups that are scheduled to be consumed by a patient. Referring to step of FIG. 3, code may be written to cause the computer to access an institution's dietary software system. A record for each patient's meal regimen may be extracted from the dietary software system and, once the meal regimen is extracted, the individual food items (e.g., bread, apple, pudding, etc.) are determined as shown on step 32. Alternatively, each food item may be directly extracted from the dietary software system in a single step. Moving to step 34, the computer may be instructed to determine the level of “linking” in the food-ingredient group table 11. If the linking is at the “food item” level, the computer may be instructed to search the food-ingredient group table 11 for all food items matching the patient's meal regimen as shown in step 36. Matching food items and the linked ingredient groups may be extracted from the food-ingredient group table and placed in a new table, which is referred to as the personalized food-ingredient group table 12. If the linking in the food-ingredient table 11 is at a lower level, e.g., the “ingredient” level, the computer may be instructed to determine the ingredients of each food item as shown at step 38. Once each ingredient is determined, the computer may be instructed to search the food-ingredient group table 11 for each ingredient of the food item, thus determining the ingredient groups linked to each food. Matching foods and the linked ingredient groups may be extracted and placed in the personalized food-ingredient group table 12 as shown in step 40.

Similarly, code may be written to cause the computer to determine the contraindicated ingredient groups for a particular patient. Referring to step 50 of FIG. 4, code may be written to cause the computer to create a Physicians' Orders database. Alternatively, code may be written to cause the computer to interface with an existing Physicians' Orders database. In either case, data from a Physicians' Orders database may be obtained by the computer. Using the information from the Physicians' Orders database, the drug regimen of a particular patient may be determined, as shown in step 52. Moving to step 54, the computer may access a table, e.g., a drug-ingredient group table, to create a table of contraindicated ingredient groups for each particular drug in the patient's drug regimen. The table created is the personalized drug-ingredient group table 17.

Referring now to FIG. 5, the personalized contraindicated ingredient group table 18 is derived from the personalized drug-ingredient group table 17 and compared to the personalized food-ingredient group table 12 as shown in step 68 and step 70. Moving to step 72, the computer determines if there is a common ingredient group between the two tables. If a common ingredient group were not found, then a drug-to-food interaction would not occur and a message may be displayed on the display 210. If, however, the computer were to find a common ingredient group between the personalized contraindicated ingredient group table 18 and the personalized food-ingredient group table 12, then a drug-to-food interaction may occur and an alert or warning message may be displayed on the display 210, as indicated in step 76. Moving to step 78 and step 80, the computer may be instructed to display the particular food item or the particular ingredient group that may cause the drug-to-food interaction.

At step 82, the computer may be instructed to search for alternative food items and suggest possible replacement food items that will not cause a drug-to-food interaction. This step may be carried out in various ways. One example, which is shown schematically in FIG. 5 at blocks 82a-82c, is to determine the nutritional content or other characteristic (e.g., fiber content) of a given ingredient group that is contraindicated and, therefore, is being omitted from the menu or meal regimen for a given individual; and, then, based on that information, propose a non-contraindicated substitute having the same or similar nutritional value or other characteristic. To make the proposal, a possible substitute food is proposed at block 82a; and then methods described above may be carried out to determine whether a proposed substitute food is contraindicated (block 82b); if not contraindicated, then the proposal can be made at block 82c. For example, a leafy vegetable for a starchy vegetable. Examples of sub-steps, subroutines, or object-oriented routines are presented in blocks 82a—82c in FIG. 5, to carry out the suggesting of possible food substitutes. Alternatively, the computer may be instructed to find a food item in the same food group, e.g., substitute wheat bread for white bread.

While particular embodiments of the invention have been described in detail, it is understood that the invention is not limited correspondingly in scope, but includes all changes, modifications and equivalents coming within the spirit and terms of the claims appended hereto.

What is claimed is:

1. A method of reducing the likelihood of drug-to-food interactions, comprising the steps of:
comparing the ingredient groups in at least one of a food, food group, meal and snack intended for serving to an individual with contraindicated ingredient groups with respect to a drug regimen of the individual; and
providing an output representative of contraindications encountered.

2. The method according to claim 1, wherein the step of comparing the ingredient groups includes at least one ingredient group that is a food item.

3. The method of claim 1, wherein the step of providing an output representative of the contraindications encountered includes reporting the particular ingredient group that caused the contraindication encounter.

4. The method of claim 1, wherein the step of providing an output representative of the contraindications encountered includes reporting the at least one of a food, food group, meal and snack that caused the contraindication encounter.

5. The method of claim 1, wherein the step of providing an output representative of the contraindications encountered includes suggesting a substitute for the at least one of a food, food group, meal and snack that will not cause a contraindication encounter.

6. The method of claim 1, further comprising the step of creating an ingredient group table, wherein the ingredient group table includes at least one ingredient group, the ingredient group causing an adverse reaction when combined with a drug in an individual.

7. The method of claim 6, wherein the step of creating the ingredient group table includes ingredient groups that are a subset of the at least one of a food, food group, meal and snack.

8. The method of claim 6, wherein the step of creating the ingredient group table includes ingredient groups that are equal to the at least one of a food, food group, meal and snack.

9. The method of claim 6, wherein the step of creating the ingredient group table includes ingredient groups that are a super set of the at least one of a food, food group, meal and snack.

10. The method of claim 6, further comprising the steps of:
creating a drug-ingredient group table, wherein the drug-ingredient group table includes at least one drug linked to at least one ingredient group, the ingredient group causing an adverse reaction when combined with the drug in an individual; and
creating a food-ingredient group table, wherein the food-ingredient group table includes at least one of a food, food group, meal and snack linked to at least one corresponding ingredient group.

11. The method of claim 10, further comprising the step of determining the at least one of a food, food group, meal and snack to be served to an individual from the individual's meal regimen.

12. The method of claim 11, further comprising the steps of:
creating a personalized drug-ingredient group table, wherein the personalized drug-ingredient group table is determined from the drug-ingredient group table and the individual's drug regimen; and
creating a personalized food-ingredient group table, wherein the personalized food-ingredient group table is determined from the food-ingredient group table and the individual's meal regimen.

13. The method of claim 12, further comprising the step of:
creating a personalized contraindicated ingredient group table, wherein the personalized contraindicated ingredient group table includes each contraindicated ingredient group listed in the personalized drug-ingredient group table.

14. The method of claim 13, wherein the step of providing an output representative of contraindications encountered is determined from common ingredient groups between the personalized contraindicated ingredient group table and the personalized food-ingredient group table.

15. A computer system for reducing the likelihood of drug-to-food interactions, comprising:
a processor;
a computer program executed by the processor to cause the computer to:
compare the ingredient groups in at least one of a food, food group, meal and snack intended for serving to an individual with contraindicated ingredient groups with respect to a drug regimen of the individual; and
provide an output representative of contraindications encountered.

16. The computer system of claim 15, wherein ingredient groups include at least one ingredient that is a food item.

17. The computer system of claim 15, wherein the output includes the particular ingredient group that caused the contraindication encounter.

18. The computer system of claim 15, wherein the output includes the at least one of a food, food group, meal and snack that caused the contraindication encounter.

19. The computer system of claim 15, wherein the output includes a substitute for the at least one of a food, food group, meal and snack that will not cause a contraindication encounter.

20. The computer system of claim 19 wherein the substitute for the at least one of a food, food group, meal and snack that will not cause a contraindication encounter is a food item of substantially equivalent nutritional value.

21. The computer system of claim 19, wherein the substitute for the at least one of a food, food group, meal and snack that will not cause a contraindication encounter is a food item in the same food group.

22. The computer system of claim 15, wherein the computer program executed by the processor causes the computer to:
create an ingredient group table, wherein the ingredient group table includes at least one ingredient group, the ingredient group causing an adverse reaction when combined with a drug in an individual.

23. The computer system of claim 22, wherein the ingredient group table includes ingredient groups that are a subset of the at least one of a food, food group, meal and snack.

24. The computer system of claim 22, wherein the ingredient group table includes ingredient groups that are equal to the at least one of a food, food group, meal and snack.

25. The computer system of claim 22, wherein the ingredient group table includes ingredient groups that are a super set of the at least one of a food, food group, meal and snack.

26. The computer system of claim 22, wherein the computer program executed by the processor causes the computer to:
create a drug-ingredient group table, wherein the drug-ingredient group table includes at least one drug linked to at least one ingredient group, the ingredient group causing an adverse reaction when combined with the drug in an individual; and
create a food-ingredient group table, wherein the food-ingredient group table includes at least one of a food, food group, meal and snack linked to at least one corresponding ingredient group.

27. The computer system of claim 26, wherein the computer program executed by the processor causes the computer to:
determine the at least one of a food, food group, meal and snack to be served to an individual from the individual's meal regimen.

28. The computer system of claim 27, wherein the computer program executed by the processor causes the computer to:
create a personalized drug-ingredient group table, wherein the personalized drug-ingredient group table is determined from the drug-ingredient group table and the individual's drug regimen; and
create a personalized food-ingredient group table, wherein the personalized food-ingredient group table is determined from the food-ingredient group table and the individual's meal regimen.

29. The computer system of claim 28, wherein the computer program executed by the processor causes the computer to:
create a personalized contraindicated ingredient group table, wherein the personalized contraindicated ingredient group table includes each contraindicated ingredient group listed in the personalized drug-ingredient group table.

30. The computer system of claim 29, wherein the output representative of contraindications encountered is determined from common ingredient groups between the personalized contraindicated ingredient group table and the personalized food-ingredient group table.

31. The computer system of claim 29, further comprising a communications interface, wherein the communications interface allows the computer system to communicate to a plurality of computer systems.

32. The computer system of claim 31, wherein the ingredient group table, the drug-ingredient group table and the food-ingredient group table reside on a central computer system and may be accessed through the communications interface by at least one remote computer system.

33. The computer system of claim 26, wherein the ingredient group table, the drug-ingredient group table and the food-ingredient group table reside on a central computer system and may be accessed through a communications interface by at least one remote computer system.

34. The computer system of claim 15, further comprising a communications interface, wherein the communications interface allows the computer system to communicate to a plurality of computer systems.
